(19) United States
(12) Patent Application Publication
(10) Pub. No.: US 2015/0153512 A1
(43) Pub. Date: Jun. 4, 2015

(54) DIRECTIONAL COUPLER

(71) Applicant: Fraunhofer-Gesellschaft Zur Förderung Der Angewandten Forschung E.V., Munchen (DE)

(72) Inventors: Norbert GROTE, Berlin (DE); Ziyang ZHANG, Berlin (DE); Francisco SOARES, Berlin (DE); Garri GENRICH, Potsdam (DE)

(21) Appl. No.: 14/616,555

(22) Filed: Feb. 6, 2015

Related U.S. Application Data
(63) Continuation-in-part of application No. PCT/EP2013/066646, filed on Aug. 8, 2013.

(30) Foreign Application Priority Data
Aug. 8, 2012 (EP) 12179654.4
Nov. 2, 2012 (EP) 12191078.0

(51) Int. Cl. G02B 6/28

(52) U.S. Cl. CPC G02B 6/2804

(57) ABSTRACT

A directional coupler comprising a first and a second optical waveguide extending at least partially parallel to one another is provided. The first and the second optical waveguide are arranged on a substrate in such a way that they extend in common plane running essentially parallel to the substrate. The first and the second optical waveguide are embedded in a polymer cladding. The first optical waveguide comprises a dielectric core and the second optical waveguide comprises a polymer core, or both the first and the second optical waveguide comprise a polymer core, wherein the cross section and/or the composition of the polymer cores is different.

### CROSS REFERENCE TO RELATED APPLICATIONS

This application is a continuation-in-part of international application no. PCT/EP2013/066646, filed Aug. 8, 2013, which claims priority to European patent application nos. 12179654.4, filed Aug. 8, 2012 and 12191078.0, filed Nov. 2, 2012. The foregoing applications are incorporated herein by reference.

### BACKGROUND

The invention relates to a directional coupler.

Optical directional couplers comprising at least one polymer waveguide are known from the prior art. In particular, such a directional coupler could be used as a tuneable wavelength filter as described in DE 1 002 53 07 B4.

### SUMMARY

It is an objective of the present invention to provide a directional coupler with enhanced tuning capabilities.

According to the invention, a directional coupler is provided, comprising
a first and a second optical waveguide extending at least partially parallel to one another, wherein
the first and/or the second optical waveguide has a polymer cladding and a core that at least partially comprises or consists of a dielectric material.

The first and the second optical waveguide each comprises an input ending providing an input port of the directional coupler and an output ending providing an output port of the directional coupler. Further, the optical waveguides are configured and arranged relative to one another in such a way that an optical wave coupled into one of the two waveguides via its input ending will be transferred to the other waveguide only if the wavelength of the optical wave fed into the waveguide lies in a wavelength range around a (tuneable) centre wavelength. Thus, the directional coupler according to the invention can be operated as a wavelength selective optical filter, wherein the input port of the filter is the input ending of one of the two optical waveguides and the output port of the filter is the output ending of the other optical waveguide. Possible configurations permitting the tuning of the centre wavelength of the filter will be discussed below.

The first and the second optical waveguide are, for example, arranged on a substrate (e.g. a silicon substrate or another semi-conductor or non-semi-conductor substrate) in such a way that they extend in a common plane running essentially parallel to the substrate. In other words, the first and the second optical waveguide are arranged in a lateral and not in a vertical configuration. The lateral configuration may have the advantage over a vertical configuration that both the first and the second optical waveguide can be used for changing the centre wavelength of the directional coupler, i.e. for wavelength tuning.

For example, both the first and the second optical waveguide are embedded in a polymer cladding, and wherein the first optical waveguide comprises a dielectric core and the second optical waveguide comprises a polymer core.

The dielectric core of at least one of the optical waveguides may provide a difference of the effective refractive indices of the two waveguides large enough to enable wavelength tuning by exploiting the well-known principle of grating assisted couplers (as described e.g. in the publication “Directional couplers made of non-identical asymmetrical slabs, Part II: Grating assisted couplers”, J. Lightwave Technol. vol. 5, 268-273 (1987), M. Marcuse, which is incorporated by reference herewith). Furthermore, it may also provide a different thermo-optical coefficient, which may improve the tuning characteristics of the directional coupler. In particular, only one of the optical waveguides comprises a dielectric core embedded in a polymer cladding material or polymer waveguide core material, whereas the other waveguide does not. However, it is also conceivable that both the first and the second optical waveguide comprise a polymer cladding embedding a dielectric core, the cores in that case having different dielectric materials, i.e. different refractive indices.

In particular, the directional coupler according to the invention is an asymmetric directional coupler, i.e. the effective refractive index of the first optical waveguide is different from the effective refractive index of the second optical waveguide (taken at the same temperature of the first and the second optical waveguide). According to an embodiment of the invention, only the first optical waveguide comprises or consists of a dielectric core, wherein the dielectric core is configured in such a way that the effective refractive indices of the first and the second optical waveguides differ by some 0.01-0.03, to indicate an exemplary reasonable range. The refractive index of the dielectric core may be significantly higher than the refractive index of the polymer cladding, e.g. the dielectric core material has a refractive index of about 1.8-about 2 at a wavelength of 1550 nm; in particular, distinctly larger than that of the embedding polymer material with typical values between some 1.35-1.6.

For example, the complete core of one of the optical coupler waveguides is formed by a dielectric material. However, it is also possible that the waveguide core is formed by a polymer core (formed by a polymer material different than the polymer material of the cladding), wherein a dielectric material is embedded in the polymer core (combined polymer/dielectric core, which will be equally termed “dielectric core” in the following). Suitable dielectric materials for the waveguide core are, for example, silicon nitride (SiNₓ), silicon oxynitride (SiON), tantalum oxide, titanium oxide and/or aluminium oxide. Of course, other materials can be used as dielectric core material, provided that they exhibits low optical loss (in respect to the used optical wavelengths) and are compatible with the polymer cladding.

Further, the dielectric core of one of the optical waveguides of the coupler (different than in, for example, conventional silicon oxide waveguides having a silicon nitride core) may also create a waveguide having a thermo-optical coefficient (TOC) different (e.g. lower) from the TOC of the non-dielectric core waveguide. This is due to the fact that the dielectric core material may have a significantly lower TOC (e.g. about +(1−2)*10⁻⁵ K⁻¹) than the polymer cladding (e.g. about −1.1*10⁻⁴ K⁻¹). Taking into account and depending on weighed confinement factors of the light intensity in the cladding and the core, the effective TOC of the dielectric core waveguide may be significantly lower than the TOC of a pure polymer waveguide. The lower TOC of the waveguide may improve the tuning characteristics of the directional coupler.

In an asymmetric directional coupler a periodic variation of the effective refractive index of at least one of the optical coupler waveguides (along the length of the respective optical waveguide) may be provided in order to permit the light fed into one of the waveguides to be transferred to the other coupler waveguide. In particular, one of the waveguides is provided with a grating-like variation of the effective refractive index (e.g. by providing a grating-like variation the dimensions of the waveguide core), i.e. the directional coupler is formed as a “grating assisted coupler” (GAC). In particular, only one of the two coupler waveguides comprises a grating. The grating-like variation of the effective refractive may be achieved by providing a waveguide core whose dimensions (the width measured parallel to the substrate and for the thickness measured perpendicular to the substrate) vary periodically along at least a portion of the length of the optical waveguide.

In a GAC a transfer of optical power from one of the coupler waveguides into the other one is possible for a resonant coupling wavelength λ (defining the “centre wavelength” mentioned above of the optical filter provided by the directional coupler), wherein λ is given by:

λ=Δn_{eff}Λ

wherein Δn_{eff} is the difference of the effective refractive indices of the first and the second optical waveguide of the directional coupler and Λ is the periodic length of the grating.

According to an embodiment of the invention, only the first optical waveguide has a polymer cladding and a dielectric core, wherein the second optical waveguide has a nondielectric core (e.g. a polymer core), wherein the thickness and/or the width of the dielectric core of the first optical waveguide varies periodically along the length of the first optical waveguide such that the refractive index grating mentioned above is created. For example, assuming a centre wavelength of λ=1550 nm and Δn_{eff}=0.02, which can be realized because of the dielectric core of the first optical waveguide, a grating period Λ of 77.5 μm is required, which can be readily realized by conventional lithographic methods.

Different from a symmetric directional coupler the coupling wavelength (the centre wavelength) of an asymmetric coupler may be changed by changing the effective refractive index difference Δn_{eff}. The difference Δn_{eff} may be changed by changing the effective refractive index of the first and/or the second optical waveguide of the directional coupler, e.g. by changing the temperature of the waveguide(s) (thermo-optic refractive index control) or by applying an electric field across the waveguide(s) if electro-optic polymer material is used in the latter case. Regarding the thermo-optic refractive index control the inducable temperature dependent wavelength change Δλ/ΔT is given by:

Δλ/ΔT=Δ(Δn_{eff}Λ)/ΔT=(TOC₁−TOC₂)*Λ and

Δλ=(TOC₁ΔT₁−TOC₂ΔT₂)*λ/Δn_{eff}

wherein TOC₁ and TOC₂ are the thermo-optic coefficients of the first and the second optical waveguide, respectively, and ΔT₁ and ΔT₂ is the induced temperature change of the first and the second optical waveguide, respectively.

The directional coupler according to the invention may correspondingly comprise a heating device for heating the first and/or the second optical waveguide. For example, the heating device is configured for heating the first and the second optical waveguide in such a way that the temperature of the first and the second optical waveguide can be altered essentially independently from one another. That is, the two optical waveguides may be sufficiently thermally isolated (e.g. by a common polymer cladding surrounding the core of the first and the second waveguide, favoured by the generally low thermal conductivity of polymer materials) such that the waveguides may assume different temperatures. For example, the heating device comprises at least two separate heating electrodes, wherein at least one heating electrode is assigned to the first optical waveguide and at least one heating electrode is assigned to the second optical waveguide.

For example, the heating device comprises at least one electrode that is embedded in the polymer cladding of the directional coupler (the polymer cladding, for example, enclosing both the first and the second optical waveguide).

Further, the heating device may comprise at least one heating electrode that is arranged between the core of the first or the second optical waveguide and a substrate (on which the optical waveguides are arranged).

Alternatively or in addition, the heating device may comprise at least one heating electrode that is arranged laterally of the first or the second optical waveguide; i.e. one a lateral side of one of the waveguides that faces away from the other waveguide. For example, the laterally arranged heating electrode (which may be formed as a plate) extends transversely with respect to a substrate on which the first and the second optical waveguide are arranged.

It is, of course, also possible that only one heating electrode is provided such that only one waveguide can be heated. Further, it is conceivable that the heating device is configured for simultaneously heating the first and the second optical waveguide, making use of the different TOCs of the waveguides. For example, the heating device comprises a single heating electrode assigned to both the first and the second optical waveguide (having different thermo-optical coefficients). The heaters may be applied to the top of the waveguide structures but also at the bottom or at the sidewalls of etched mesa-like stripes encompassing both of the waveguides.

The invention also relates to an optical add-drop multiplexer (OADM) that comprises a directional coupler as described above. For example, an input port of the first or the second optical waveguide of the directional coupler is connected to different WDM-channels (WDM=wavelength division multiplex), wherein using the directional coupler a wavelength channel can be deselected (drop function) and/or added (add-function) by tuning the device to this particular wavelength. The directional coupler according to the invention may allow a relatively broad tuning range such that optical add-drop-multiplexer for coarse wavelength division multiplex (CWDM) applications may be realized which do not require particularly narrow filter characteristics. For example, an optical add-drop multiplexer for four CWDM-channels having, for example, 20 nm channel spacing may be fabricated.

Also, the directional coupler according to the invention may be used as a wavelength tuneable/wavelength selectable thermo-optical wavelength switch or power divider; in particular, as a 2×2 wavelength switch or power divider. According to this embodiment, light of a predetermined wavelength will be fed into one of the coupler waveguides and if the wavelength matches the coupling wavelength of the coupler, the light will be transferred to the other coupler waveguide (or vice versa). This switch can be operated with low losses, in particular, essentially as a no-loss device (apart from inevitable waveguide or fabrication induced losses).

A complete switching may already be achieved by inducing small temperature changes (e.g. a temperature rise of not more than 10 K) depending on the spectral characteristic of the directional coupler. For example, the centre wavelength (i.e. the maximum of the transmitted spectrum) of the directional coupler is tuned to the input wavelength as set forth above. It is, however, also possible that the directional coupler is tuned in such a way that the input wavelength lies on an edge of the transmitted wavelength range of the coupler such that only a (first) portion of the input power is transferred to the other waveguide, whereas a second portion of the input power remains in the input waveguide. Thus, the directional coupler may be used as an optical power divider having an adjustable split ratio.

According to another embodiment of the invention, a tuneable laser device comprising an intra-cavity filter for selecting an output wavelength of the laser is provided, the intracavity filter comprising a directional coupler as discussed above. Thus, the directional coupler is used as a widely tuneable filter for tuning the laser. For example, an input port (i.e. an ending) of the first or the second optical waveguide of the directional coupler is connected to a laser active component (gain component), wherein an output port of the other optical waveguide is connected to a reflecting element (e.g. a multiple peak reflector) of the laser. The directional coupler is used to select one of the plurality of cavity modes permitted by the reflecting element, wherein a cavity mode wavelength is selected by tuning the centre wavelength of the directional coupler as described above (e.g. by heating at least one of the coupler waveguides).

In particular, the laser device is a hybrid device, wherein at least the gain component is a semiconductor component (i.e. in particular, its laser active part is a semi-conductor structure) and the directional coupler is formed as a polymer component (having at least one polymer waveguide) according to the invention. Accordingly, the gain component and the coupler are arranged on different substrates connected to one another.

Further, the invention also relates to a tuneable laser device comprising a first and a second laser and a directional coupler as described above, wherein light emitted by the first laser is coupled into the first optical waveguide of the directional coupler and light emitted by the second laser is coupled into the second optical waveguide of the directional coupler. In particular, the first and the second lasers are designed as waveguide grating lasers (WGL) containing waveguides with tuneable Bragg gratings.

The two Bragg grating loaded waveguides are, for example, integrated on a common substrate (chip) and hybridly integrated with semi-conductor devices to form a dual WGL structure. The two lasers further are connected to an output port of the laser device via the directional coupler, wherein light emitted by one of the waveguides of the directional coupler is guided towards that output port.

In particular, the two waveguide grating lasers cover different tuning ranges, wherein depending on the desired output wavelength either the first or the second laser is operated. The coupling wavelength of the directional coupler is selected correspondingly such that light of the active laser is guided towards the output port of the laser device. In that example, the directional coupler operates as a switch, which, in particular, has low optical losses and has to only operate in half of the tuning range of the laser device and requires little heating power due to its efficiency.

It is also possible to operate the directional coupler in such a way that only a portion of the optical power generated by the first or the second laser of the laser device is transferred between the optical waveguides of the directional coupler such that a portion of the power will be emitted via a second output port of the directional coupler. This configuration may be used, for example, in optical coherent transceivers for using the same laser device simultaneously as a local oscillator laser and an externally modulated transmitting laser.

According to another aspect, the invention relates to an optical waveguide, in particular for use in a directional coupler as discussed above, the optical waveguide comprising:
a polymer cladding; and
a core that at least partially comprises or consists of a dielectric material.

The optical waveguide according to the invention may be configured as described above with respect to the first and/or the optical waveguide of directional coupler. For example, the optical waveguide may comprise a pure dielectric core or a polymer core surrounding another core material consisting of a dielectric material.

According to an embodiment, only a section of the waveguide comprises a core with a dielectric material. In particular, the waveguide comprises a first section having a dielectric core and a second section having a non-dielectric (e.g. polymer) core. For example, the optical waveguide comprises a plurality of alternating sections having dielectric and non-dielectric cores.

Further, the transition regions between the different waveguide sections may be (in particular adiabatically) tapered, i.e. the width (measured parallel to the substrate on which the optical waveguide is arranged) and/or the thickness (measured perpendicular to the substrate) of the dielectric core decreases towards the non-dielectric core portion of the waveguide.

In particular, the optical waveguide may comprise a facet region with a dielectric core, wherein other portions of the waveguide may not comprise a dielectric core. The dielectric core in the facet region of the waveguide may increase the waveguide aperture (in particular, in the vertical direction, i.e. perpendicular to the substrate) such that the waveguide mode profile may be better matched to optical components that are to be coupled to the waveguide, for example a laser diode (e.g. in a ridge waveguide configuration) having, e.g., an elliptical cross section. The width and/or the thickness of the dielectric core at the facet may be designed such that the coupling losses are reduced in comparison with a pure polymer waveguide.

Further, the waveguide may comprise a Bragg grating, wherein, in particular, the dielectric waveguide core forms the Bragg grating. Also, the optical waveguide may comprise a phase shifting device, which, for example, comprises at least one heating electrode.

### BRIEF DESCRIPTION OF THE DRAWINGS

Embodiments of the invention will be explained in more detail hereinafter with reference to the drawings.

FIG. 1 schematically depicts an optical waveguide according to an embodiment of the invention.

FIG. 2 schematically depicts an optical waveguide according to another embodiment of the invention.

FIG. 3 the difference of the effective refractive index depending on the thickness of the dielectric waveguide core.

FIG. 4 depicts a segmented optical waveguide according to yet another embodiment of the invention.

FIG. 5 depicts a modification of the optical waveguide of FIG. 4.

FIG. 6 illustrates overlap of the optical mode at the facet of the waveguide of FIG. 4 with a mode of an optical component.

FIG. 7A shows a direction coupler according to an embodiment of the invention.

FIG. 7B shows a cross sectional view of the direction coupler of FIG. 7A.

FIGS. 8A, 8B illustrate a heat-induced change of the wavelength characteristics of the directional coupler according to the invention.

FIG. 9 illustrates the potential tuning range of the directional coupler according to the invention.

FIG. 10 depicts a sectional view of the directional coupler according to an embodiment of the invention.

FIG. 11 depicts a schematic sectional view of the directional coupler according to another embodiment of the invention.

FIG. 12 schematically illustrates the use of the directional coupler according to the invention in an add-drop multiplexer.

FIG. 13 illustrates the working principle of the add-drop multiplexer shown in FIG. 12.

FIG. 14 illustrates the use of the directional coupler according to the invention as a wavelength dependent switch.

FIG. 15 schematically illustrates the working principle of the switch shown in FIG. 14.

FIG. 16 schematically illustrates a tuneable laser device comprising a directional coupler according to the invention.

FIG. 17 schematically illustrates another tunable laser device comprising a directional coupler according to the invention.

FIG. 18a-18f schematically illustrates possible configurations of the laser device shown in FIG. 17.

FIG. 19 a top view of a wave guide according to another embodiment of the invention.

FIG. 20 a detailed view of the Bragg grating of the wave guide shown in FIG. 19.

### DETAILED DESCRIPTION

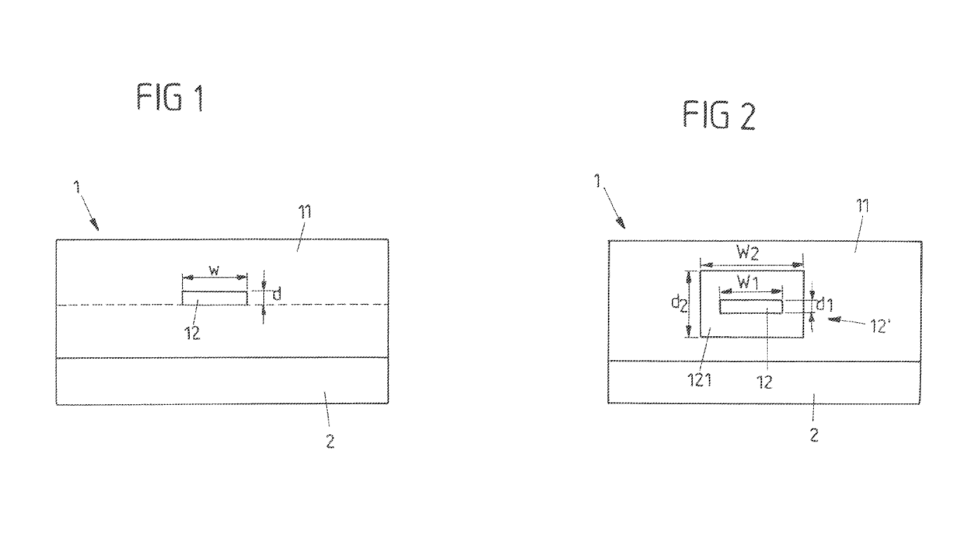

The optical waveguide 1 according to the invention illustrated in FIG. 1 is arranged on a substrate (e.g. a silicon substrate) 2, waveguide 1 further comprising a polymer cladding 11 in which a waveguide core 12 is embedded. The waveguide core 12 consists of a dielectric material such as silicon nitride. However, as mentioned above, dielectrics other than silicon nitride could be used as material for the dielectric waveguide core 12 provided e.g. that they are compatible with the polymer material used for the waveguide cladding 11 (and are sufficiently loss free in the desired wavelength range). The effective refractive index of the optical waveguide 1 depends on the width w (parallel to substrate 2) and the thickness d (perpendicular to substrate 2).

FIG. 2 illustrates another embodiment of the waveguide according to the invention, wherein the waveguide core 12′ is not exclusively formed by a dielectric material as in FIG. 1. Rather, core 12′ comprises a polymer material 121 (different from the polymer material used for the cladding 11) in which a dielectric (inner) core 12 is embedded.

The dimensions (width w₁, thickness d₁) of the dielectric inner core 12 may compare to the dimensions of dielectric core 12 of FIG. 1. The surrounding polymer core 121 may have a width w₂ of about 3.5 μm and a thickness d₂ of about 3.5 μm+d₁.

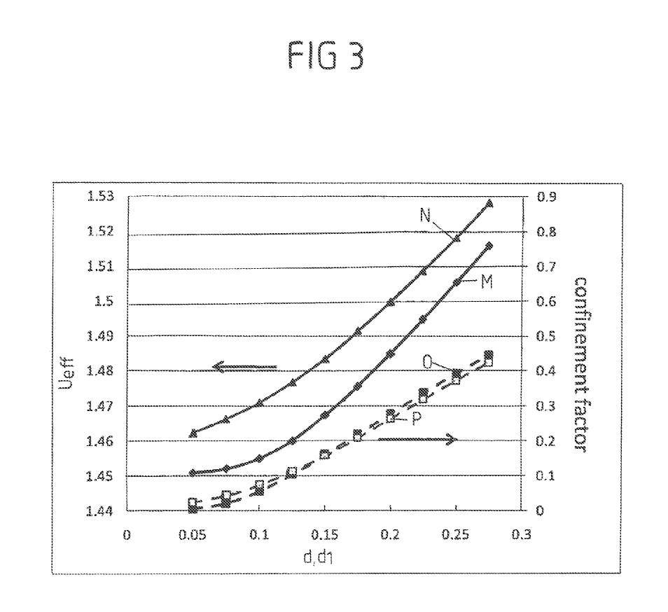

FIG. 3 illustrates the effective refractive index n_{eff} (left y-axis) and the confinement factor (right y-axis), respectively, for the two configurations of the optical waveguides shown in FIGS. 1 and 2 dependent on the thickness d, d₁ of the dielectric waveguide core 12. The refractive index increases with increasing thickness (curve M: pure dielectric waveguide core as in FIG. 1, curve N: combined polymer/dielectric core as in FIG. 2). Also, the confinement factor increases with increasing thickness (curve O: pure dielectric waveguide core, curve P: polymer and dielectric core).

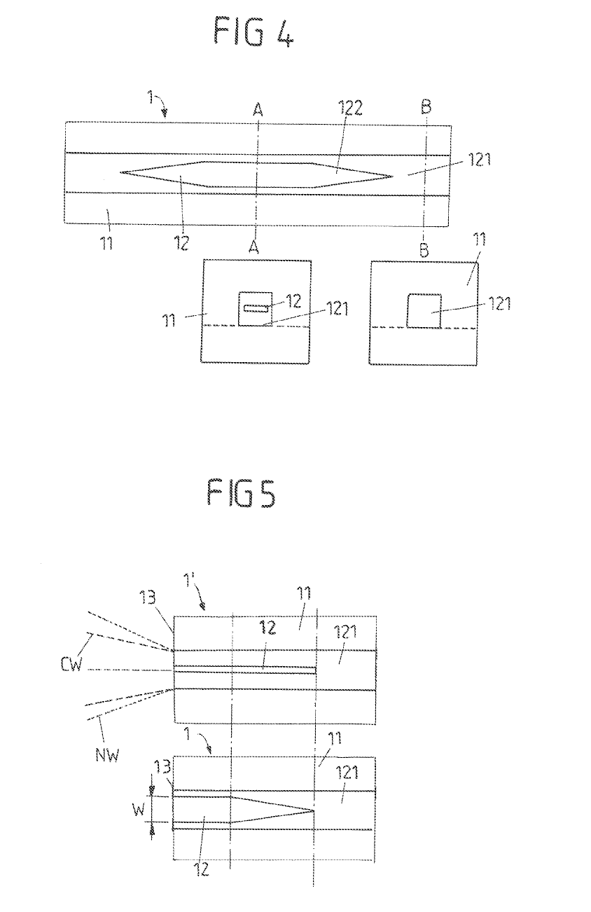

FIG. 4 illustrates another embodiment of the optical waveguide 1 according to the invention in a sectional top view (upper illustration) and in two cross sectional views taken perpendicular to the longitudinal axis of the waveguide (lower illustrations).

The optical waveguide 1 similar to FIGS. 1 and 2 comprises a dielectric core 12 embedded in a polymer cladding 11. However, the dielectric core 12 does not extend over the whole length of the optical waveguide 1. Rather, only a section of the optical waveguide 1 comprises the dielectric core, wherein other portions of the waveguide do not comprise a dielectric core, but, for example, a polymer core 121 (or a core of another material different form the material of dielectric core 12). This is depicted by the lower sectional views of the optical waveguide depicting sections A-A and B-B of the upper drawing.

Because of the different core sections, the different sections of waveguide 1 comprise different effective refractive indices. For example, the effective refractive index n_{eff,2} of the waveguide section with the dielectric core (left lower sectional view) is larger than the effective refractive n_{eff,1} outside the waveguide section with the dielectric core (right lower sectional view).

Further, the transition region between the dielectric core section and the section outside the dielectric core section may comprise a tapered core region 122, wherein the dielectric core 12 is tapered towards the adjacent section (e.g. a polymer core section), i.e. its width and/or thickness continuously (e.g. linearly or adiabatically) decreases towards the adjacent region to reduce optical transition losses between the sections.

According to FIG. 5, using a dielectric core 12 in the region of a facet 13 of waveguide 1, the aperture of waveguide 1 can be enlarged. The enlarged aperture is depicted in the upper drawing of FIG. 5 relative to the aperture of the facet of a conventional waveguide having a pure polymer core, wherein the aperture of the conventional waveguide is denominated “CW” and the aperture of the new waveguide is denominated “NW”.

The dielectric core 12 of waveguide 1 may further be tapered (lower drawing of FIG. 5) in such a way that its width w increases towards a facet 13 of the optical waveguide 1 such that the waveguide mode at the facet has a larger overlap with an optical mode of a component (particularly one featuring an elliptical mode profile; not illustrated) whose radiation is to be fed into the optical waveguide 1. Thus, the aperture of the optical waveguide 1 is enlarged, thereby reducing coupling losses.

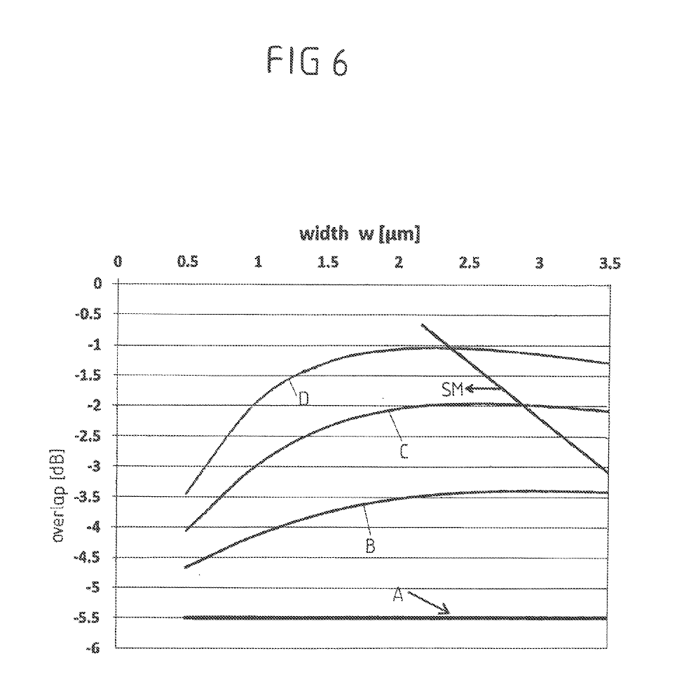

The overlap with an exemplary elliptical mode profile and the mode profile at facet 13 of waveguide 1 dependent on the width w of the dielectric core layer is depicted in FIG. 6, wherein the characteristics of the conventional waveguide (curve A) is shown together with the characteristics of the waveguide 1 according to the invention (curve B: w=15 nm, curve C: w=100 nm and curve D: w=115 nm). The conventional polymer waveguide has a polymer core (3.5×3.5 μm). The single mode regime is also indicated (curve SM).

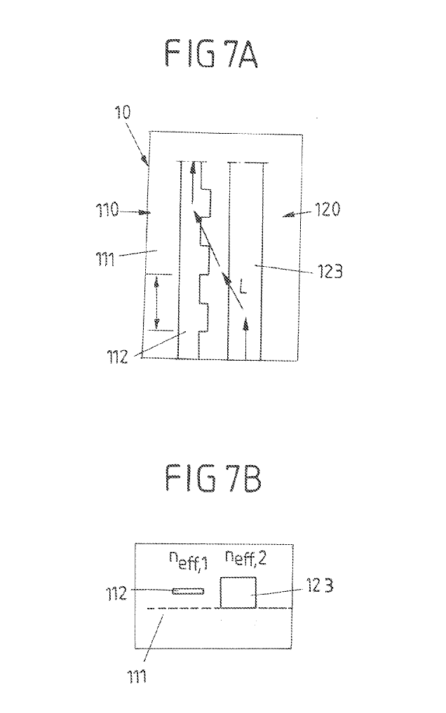

FIG. 7A illustrates a directional coupler 10 according to the invention, the directional coupler 10 comprising a first optical waveguide 110 and a second optical waveguide 120. FIG. 7B shows the first and the second optical waveguide 110, 120 in cross section.

The first optical waveguide 110 is configured similar to the optical waveguides according to the invention shown in FIG. 1, i.e. the optical waveguide 110 comprises a polymer cladding 111 and a dielectric core 112. The other waveguide 120 of the coupler 10 may be a conventional waveguide, e.g. a polymer waveguide without a dielectric core (e.g. having a pure polymer core 123). Further, the cladding 111 forms the cladding of both the first and the second optical waveguide 110, 120.

The directional coupler 10 has a lateral configuration, i.e. the first and the second waveguide 110, 120 are arranged on a substrate (similar to substrate 2 in FIG. 1), wherein the waveguides 110, 120 run parallel to one another in a common plane that extends parallel to the substrate.

Due to the fact that the first optical waveguide 110 comprises a dielectric core, it has a rather large effective refractive index such that the two waveguides 110, 120 have different refractive indices which, in principle, would prevent an optical mode in one of the waveguides from coupling into the other waveguide. However, the effective refractive index of the first optical waveguide 110 varies along the length of the waveguide 110 with a period A, wherein the longitudinal variation of the effective refractive index is generated by providing the dielectric core 112 of the first optical waveguide 110 with a grating-like variation of its width (and/or its thickness), i.e. the directional coupler 10 is a “grating assisted coupler” (GAC). Thus, a transfer (indicated by arrows L in FIG. 7A) of an optical mode (light wave) from the second optical waveguide 120 into the first optical waveguide 110 (or vice versa) is possible for a resonant wavelength which depends on the period length A as already set forth above in more detail.

Because of the dielectric core of the first optical waveguide, also the thermo-optical coefficient of the first optical waveguide 110 is different (e.g. lower) than the thermo-optical coefficient of the second optical waveguide 120. Thus, by changing the temperatures of the first and the second optical waveguide 110, 120, the difference Δn_{eff} of their effective refractive indices is altered, thereby changing the resonant (centre) wavelength of the directional coupler 10.

It is possible that both waveguides 110, 120 experience the same temperature change, wherein the tuning wavelength of the coupler 10 would still be altered due to the different thermo-optic coefficients. However, it is also possible that the first and the second optical waveguide have similar thermo-optical coefficients. In that case, the temperature of the first optical waveguide may be changed differently than the temperature of the second optical waveguide, e.g. by using separate heating electrodes as will be explained below. It is also noted that at a certain temperature (e.g. at room temperature) the effective refractive indices of the two optical waveguides may be essentially the same, wherein they are different at another temperature.

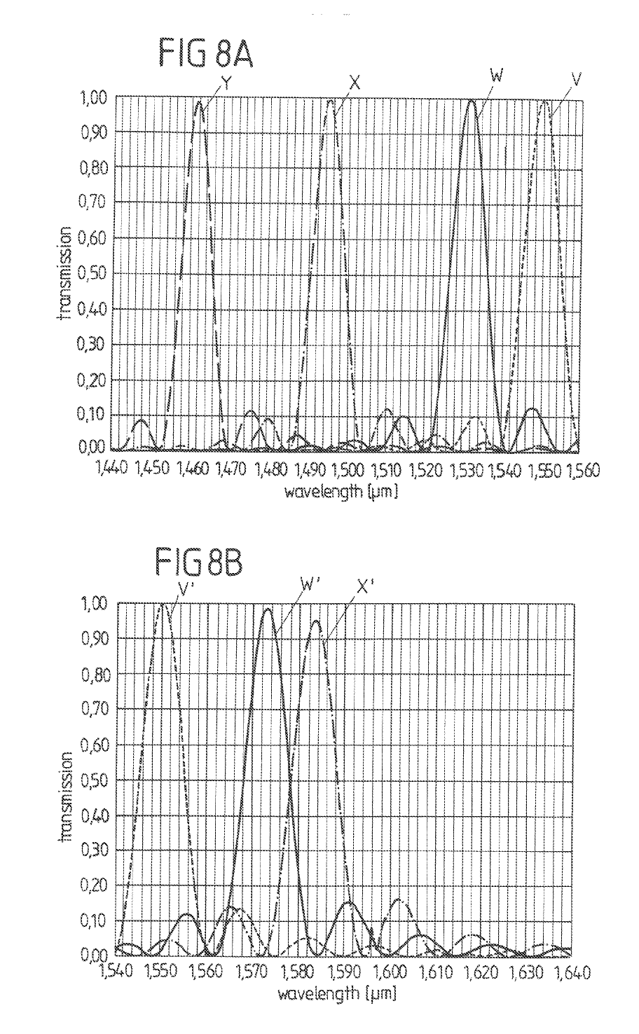

In particular, it is possible that only one of the two optical waveguides 110, 120 is heated at a time, wherein, for example, the coupling wavelength of the directional coupler 10 may be shifted towards smaller wavelengths when only the first optical waveguide 110 (comprising the grating and the dielectric core) is heated and towards larger wavelengths when only the second optical waveguide 120 (polymer waveguide without grating) is heated. This is illustrated in FIGS. 8A and 8B, wherein FIG. 8A shows the transmission of the directional coupler if only the first optical waveguide 110 experiences a change of its temperature (curve V: induced temperature change ΔT=0K, curve W: ΔT=10K, curve X: ΔT=30K and Y: ΔT=50K). FIG. 8B illustrates the transmission (filtering curve) of the directional coupler when only the second optical waveguide 120 is heated (curve V′: ΔT=0K, curve W′: ΔT=10K and X′: ΔT=15K).

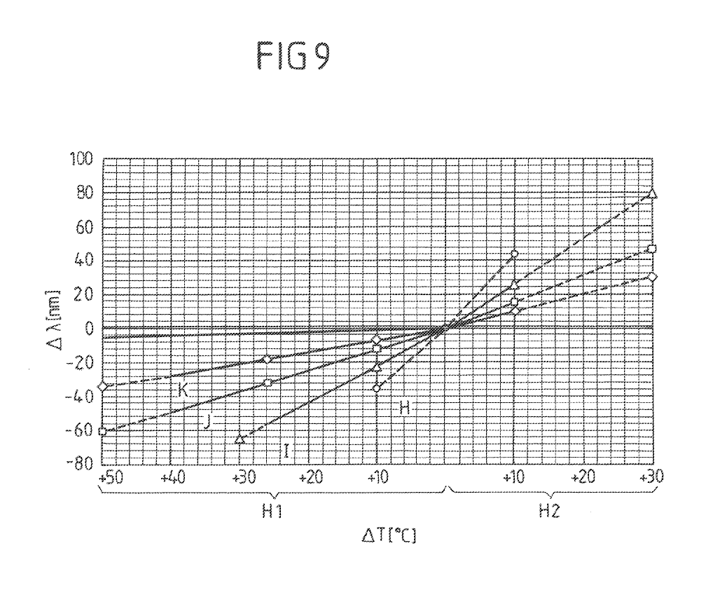

The tuning ranges shown in FIGS. 8A and 8B can be combined to obtain an overall tuning range of the directional coupler; for example as illustrated in FIG. 9 for different thicknesses d of the dielectric core relative to a middle wavelength of 1550 nm (curve H: d=100 nm; curve I: d=120 nm; curve J: d=150 nm and curve K: d=200 nm). “H1” denotes the temperature difference created by heating the dielectric core waveguide and “H2” denotes the temperature difference created by heating the polymer core waveguide of the coupler.

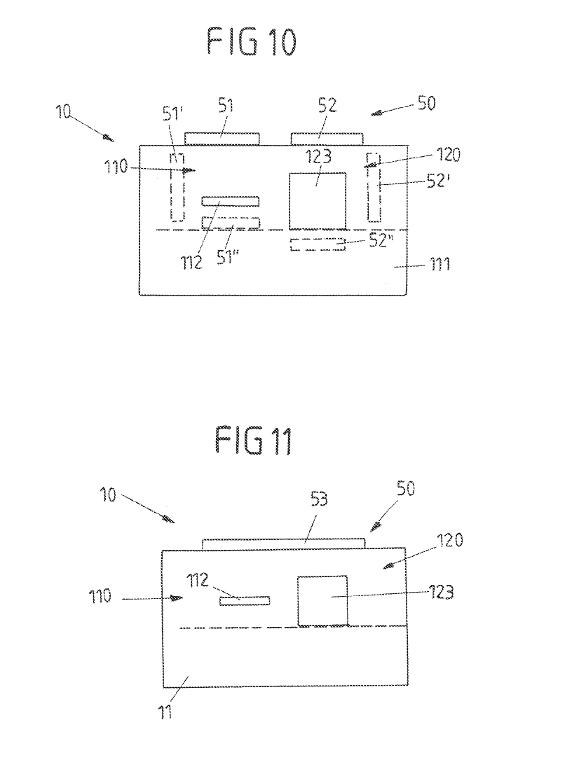

FIG. 10 shows a cross section of a further embodiment of the directional coupler 10 according to the invention. In this embodiment the coupler 10 comprises a heating device 50 comprising two heating electrodes 51, 52 assigned to the first optical waveguide 110 and the second optical waveguide 120, respectively. The heating electrodes 51, 52 are arranged in a distance from one another on top of the polymer cladding 111, i.e. on a side of the cores of the optical waveguides 110, 120 which faces away from the substrate (not illustrated in FIG. 10) of the coupler 10.

In particular, the heating electrodes 51, 52 are configured in such a way that the temperature of the waveguides 110, 120 can be changed essentially independently from one another. Of course, the heating electrodes 51, 52 do not necessarily have to be arranged on top of the waveguides. Rather, as an alternative or in addition, heating electrodes 51′, 52′, 51″, 52″ could be provided that are arranged laterally (e.g. embedded in the cladding 111) and/or below the waveguides 110, 120 (in particular below the waveguide cores) as indicated (dashed lines) in FIG. 10.

It is also possible, that a common heating electrode 53 is used assigned to both the first and the second optical waveguide 110, 120 as depicted in FIG. 11. Also in this embodiment further electrodes may be provided arranged below the waveguides as indicated in FIG. 10.

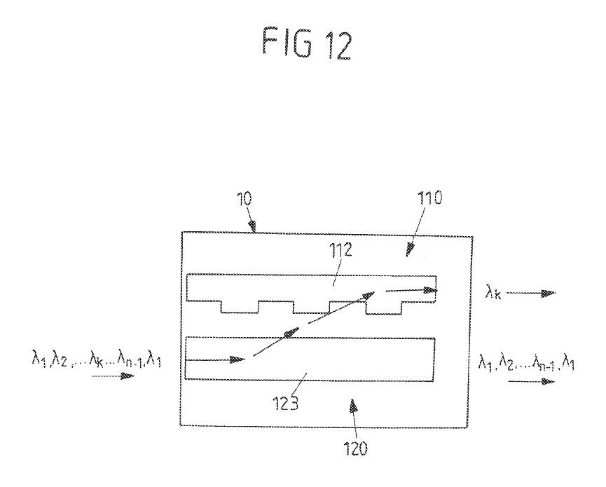

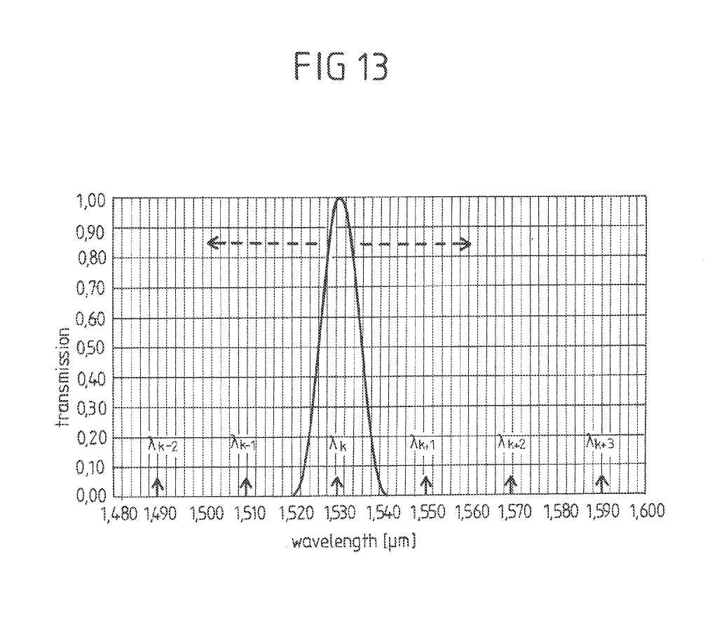

Another embodiment of the invention is illustrated in FIGS. 12 and 13, wherein the directional coupler according to the invention is used in an optical add-drop multiplexer (OADM) in such a way that a plurality of wavelength channels is connected to one of the waveguides (the second waveguide 120 according to the example of FIG. 12) of the coupler 10. Depending on the tuning wavelength of the directional coupler 10 a certain wavelength channel (λₖ) is coupled over into the other waveguide (the first waveguide 110 having the dielectric core 112) and emitted from an output facet of the first waveguide towards an output port of the coupler and the multiplexer. The selected wavelength channel λₖ can be changed by tuning the directional coupler 10 (e.g. by heating the first and/or the second optical waveguide 110, 120 as discussed above and as depicted in FIG. 13). Of course, also the first optical waveguide 110 could be used as input waveguide.

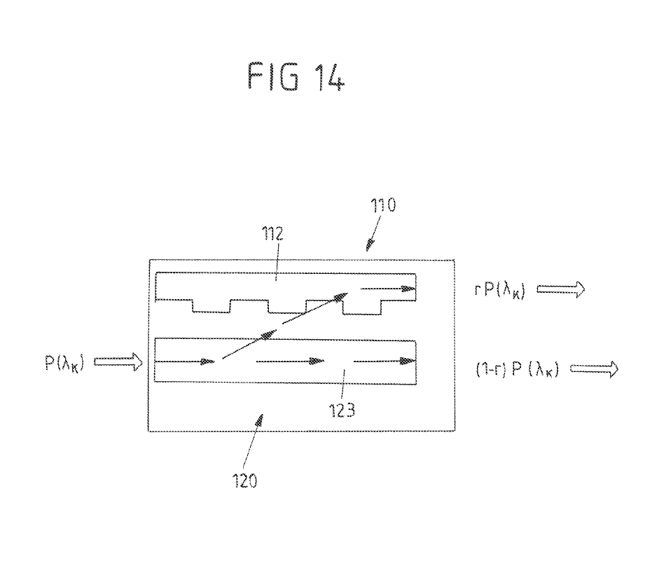

According to FIGS. 14 and 15, the directional coupler could also be used as a wavelength tuneable thermo-optical switch (2×2 switch), wherein light could be switched from one of the waveguides (lower, second optical waveguide 120) into another waveguide (upper, first optical waveguide 110) as already set forth above. Also, if the tuned-in centre wave-length of directional coupler 10 does not exactly match the input wavelength λₖ (but λₖ is located on an edge of the transmission curve of coupler 10 as shown in FIG. 15) only a portion of the power P fed into the coupler is transferred to the first waveguide 110, wherein the dividing ratio r of the switch can be adjusted such that only a portion r*P of the power coupled into the second optical waveguide 120 is transferred into the first optical waveguide 110. Accordingly, the remaining power (1−r)*P stays in the second optical waveguide 120 and is emitted from an end of the second optical waveguide 120.

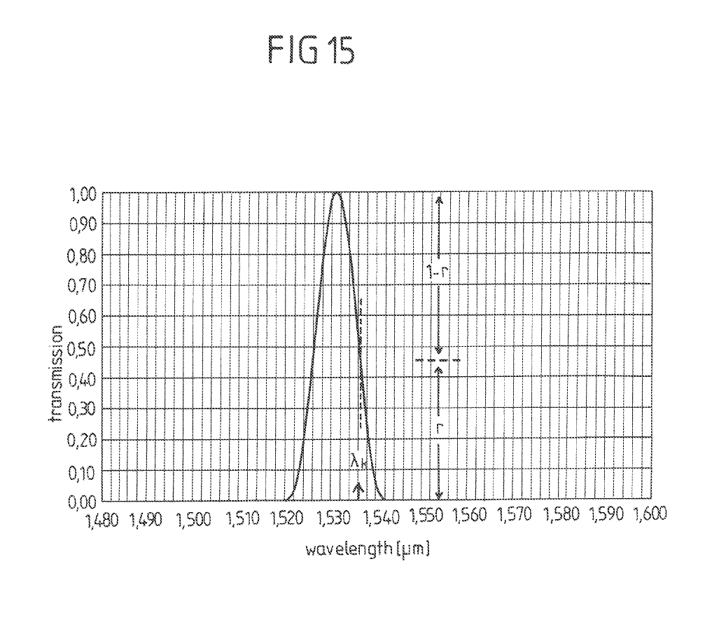

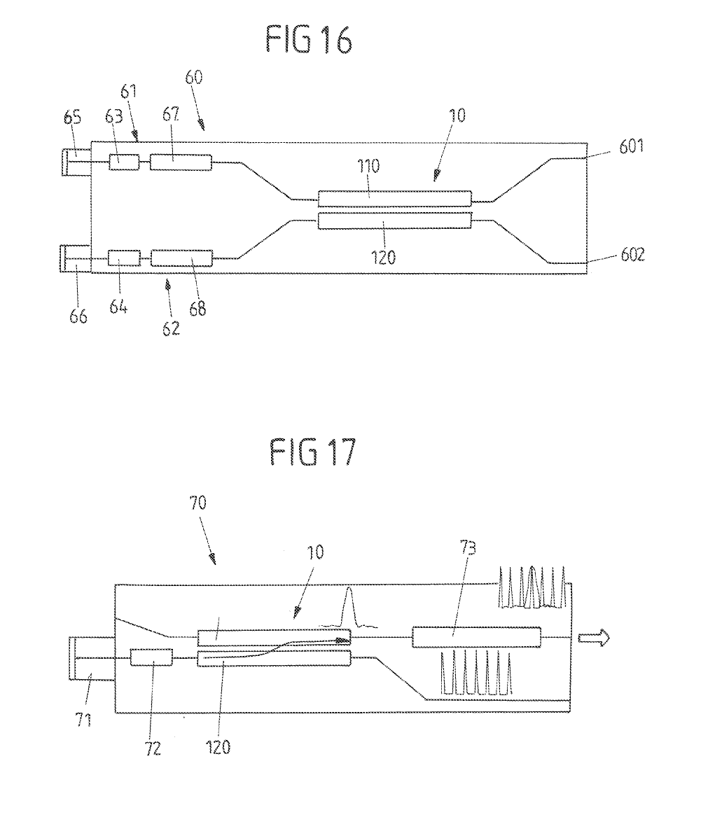

FIG. 16 relates to a tuneable laser device 60 comprising a directional coupler 10 according to the invention. The laser device 60 comprises two parallel waveguide grating lasers 61, 62, each of the lasers 61, 62 comprising a phase section 63, 64 and a gain section 65, 66. Further, the lasers 61, 62 comprise a tuneable Bragg filter 67, 68, wherein the lasers 61, 62 are coupled to the first and the second optical waveguide, respectively, of the directional coupler 10 via the Bragg filters 67, 68.

An output end of the first optical waveguide 110 is connected (e.g. via integrated waveguides) to an output port 601 of the laser device 60 and the second optical waveguide 120 is connected to a second output port 602 of laser device 60. The lasers 61, 62 have different (e.g. adjacent) tuning ranges, wherein using the directional coupler as a combiner 10 light of both lasers 61, 62 can be directed towards the same output port (the upper output port 601). The centre wavelength of the directional coupler is set depending on which one of the lasers 61, 62 is operated (as already explained above). Further, laser device 60 may be a hybrid integrated device, i.e. in particular the gain sections 65, 66 and the directional coupler are not realized as an integrated device. In particular, the gain sections 65, 66 or the lasers 61, 62 as a whole are integrated on a common chip.

FIG. 17 shows another application of the directional coupler 10 according to the invention. The coupler 10 is used as an intra cavity filter of a laser device 70 in the form of a tuneable laser comprising a gain element 71, a phase section 72 and a multiple peak reflector (comb reflector) 73. Because of the comb reflector 73 the laser device 70 comprises a plurality of equally distanced lasing wavelengths, wherein the directional coupler 10 is used to select one of these wavelengths by tuning its coupling wavelength to the desired wavelength. The comb reflector may be a SG (sample grating) or a SSG (super structure grating) reflector.

Laser device 70 may also be a hybrid integrated device, wherein some of the components may be semi-conductor (e.g. indium phosphide) based components (such as the gain element 71) and some may be polymer based components (such as the directional coupler 10), i.e., in particular, passive and/or active elements of the components are made by semiconductor layers and polymer layers, respectively.

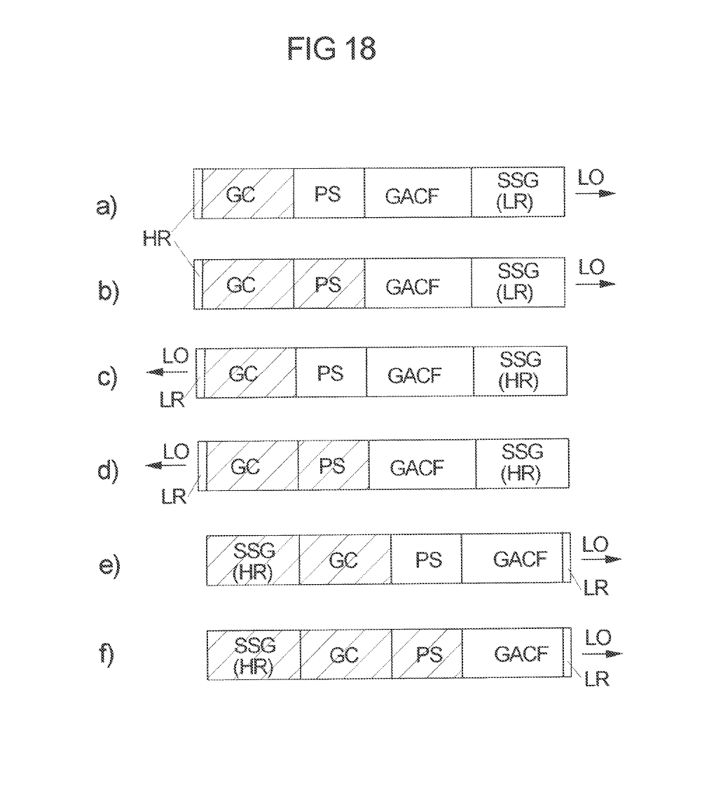

FIGS. 18a to 18f illustrate different embodiments of realising the hybrid integrated laser device 70 of FIG. 17, wherein the different embodiments comprise different configurations of the components of the laser device such as the gain section 71 (GC=“Gain Chip”), the phase section 72 (PS), the directional coupler 10 used as a cavity filter (GACF=Grating Assisted Cavity Filter), the comb reflector (SSG=Super Structure Grating), a high reflective mirror (e.g. coating) (HR) and a low reflective coating (e.g. a partially reflecting, broadband reflector in an output waveguide or a facet of the waveguide) (LR). The light output direction is indicated by “LO” (“light out”).

The different configurations of the laser device 70 may be obtained, for example, by varying the order (i.e. the location along the light path of the laser) of the components of the device. Further, some of the components may be either semi-conductor based or polymer based. For example, the phase section 72 may be either a semi-conductor or a polymer component. The semiconductor (e.g. InP) components are indicated by hatched rectangular areas, whereas the polymer components are symbolized by non-hatched areas.

The laser device configurations shown in FIG. 18a-f may have the potential to cover a tuning range corresponding to the C+L bandwidth (85 nm). Further, in comparison with WGL components the temperature change required for tuning the laser wavelength (i.e. for tuning the directional coupler as a polymer device) is relatively small, for the benefit of enhanced reliability.

It is noted that elements of different embodiments described above can, of course, also be used in combination. For example, the directional coupler used as an intra-cavity filter according to the embodiment of FIG. 17 may be equipped with at least one optical waveguide according to the embodiment of FIG. 2.

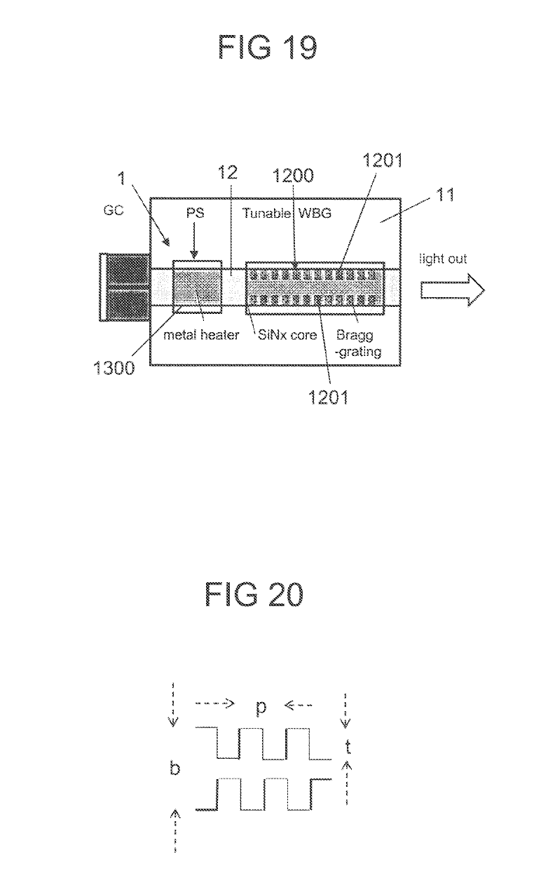

FIG. 19 illustrates another embodiment of an optical waveguide 1 according to the invention, which may be thermo-optically tuneable. The waveguide comprises a dielectric (e.g. SiNx) core 12 (e.g. a core layer) encompassed by a polymer cladding 11. The waveguide core 12 comprises a Bragg grating 1200, for example for forming a wavelength tuneable laser reflector. In particular, the waveguide is used in a waveguide grating laser.

A portion of the waveguide 1 may further comprise a (e.g. thermo-optically) tuneable section PS for phase adjustment (phase shifter) as shown in FIG. 19. The phase shifter section PS may have at least one (e.g. metallic) heating strip 1300 which may be arranged on a top, lateral and/or lower side of the waveguide 1 (similar to, for example, FIG. 10).

The Bragg grating 1200 may have a total length of approximately 0.1-1 mm, wherein the width b (FIG. 20) of its dielectric core 12 in the region of the Bragg grating 1200 may be in the region of 1.5-3 μm while the thickness (perpendicular to the waveguide) may be 50-200 nm. The Bragg grating 1200 may be formed by a single toothing located on one side of the dielectric core or by two toothings 1201 arranged on opposite side of the dielectric core 12 (as shown in FIG. 19). The period p of the Bragg grating 1200 may be in the range of 0.5 μm (first order) or an integer multiple thereof (3 p=third order, 5 p=fifth order, . . . ). Depending on, for example, the desired degree of coupling, reflection, etc. the depth t of the toothing 1201 may be chosen in such a way that a gap extending over the whole width of the dielectric core 12 is formed, i.e. the dielectric core 12 is periodically interrupted (for t>b/2).

An advantage of this embodiment may be that for fabricating a tuneable waveguide a single polymer material may be necessary, only, such that the choice of suitable polymers is less restricted. Further more, the fabrication of the waveguide may be simplified in comparison with a pure polymer waveguide such that the fabrication may be more cost efficient, in particular if the waveguide core is generated using lithographic lift-off technology.

1. A directional coupler, comprising
a first and a second optical waveguide extending at least partially parallel to one another,
wherein the first and the second optical waveguide are arranged on a substrate in such a way that they extend in common plane running essentially parallel to the substrate,
wherein the first and the second optical waveguide are embedded in a polymer cladding,
and wherein
the first optical waveguide comprises a dielectric core and the second optical waveguide comprises a polymer core, or
both the first and the second optical waveguide comprise a polymer core, wherein the cross section and/or the composition of the polymer cores is different.

2. The directional coupler as claimed in claim 1, further comprising a heating device for heating the first and the second optical waveguide, wherein the heating device is configured in such a way that the temperature of the first and the second optical waveguide can be changed essentially independently from one another.

3. The directional coupler as claimed in claim 2, wherein the heating device comprises at least one heating electrode that is embedded in the polymer cladding.

4. The directional coupler as claimed in claim 2, wherein the heating device comprises at least one heating electrode that is arranged between the core of the first or the second optical waveguide and a substrate.

5. The directional coupler as claimed in claim 2, wherein the heating device comprises at least one heating electrode that is arranged laterally of the first or the second optical waveguide.

6. The directional coupler as claimed in 5, wherein the laterally arranged heating electrode extends transversely with respect to a substrate on which the first and the second optical waveguide are arranged.

7. The directional coupler as claimed in claim 1, wherein the effective refractive index of the first optical waveguide is different from the effective refractive index of the second optical waveguide.

8. The directional coupler as claimed in claim 1, wherein the effective refractive index of the first and/or the second optical waveguide varies periodically along the respective waveguide.

9. The directional coupler as claimed in claim 8, wherein the periodic variation of the first and/or the second optical waveguide is created by varying the thickness—measured perpendicular to the substrate and/or the width measured parallel to the substrate of the dielectric material of the core of the first or the second optical waveguide, respectively.

10. The directional coupler as claimed in claim 1, wherein the thermo-optical coefficient of the first optical waveguide is different from the thermo-optical coefficient of the second optical waveguide.

11. The directional coupler as claimed in claim 1, wherein the first optical waveguide comprises a core consisting or comprising of at least one of the group comprising silicon nitride, tantalum oxide, titanium oxide and aluminium oxide.

12. The directional coupler as claimed in claim 1, wherein the first and the second optical waveguide have the same thickness measured perpendicular to the substrate, but differ in cross section.

13. A tuneable laser device comprising an intra-cavity filter for selecting an output wavelength of the laser, wherein the intra-cavity filter comprises
a directional coupler comprising a first and a second optical waveguide extending at least partially parallel to one another, wherein the first and/or the second optical waveguide has a polymer cladding and a core that at least partially comprises or consists of a dielectric material, and
a comb reflector,
wherein the directional coupler is arranged and configured for selecting one of the wavelengths reflected by the comb reflector.

14. A tuneable laser device comprising
a first and a second laser and
a directional coupler comprising a first and a second optical waveguide extending at least partially parallel to one another, wherein the first and/or the second optical waveguide has a polymer cladding and a core that at least partially comprises or consists of a dielectric material,
wherein light emitted by the first laser is coupled into the first optical waveguide of the directional coupler and light emitted by the second laser is coupled into the second optical waveguide of the directional coupler.

15. The tuneable laser as claimed in claim 14, wherein the first and the second laser are waveguide grating lasers.
